(19) United States
(12) Patent Application Publication
(10) Pub. No.: US 2026/0063532 A1
(43) Pub. Date: Mar. 5, 2026

(54) SINGLE AND MULTIPHOTON EXCITATION FLUORESCENCE IN-LINE CYTOMETRY FOR REAL-TIME BIOPROCESS METABOLIC MONITORING

(71) Applicant: Physical Sciences, Inc., Andover, MA (US)

(72) Inventors: Youbo Zhao, Westford, MA (US); William J. Kessler, Groton, MA (US); Emily Gong, Vienna, VA (US); Nareg Ohannesian, Houston, TX (US)

(21) Appl. No.: 19/202,532

(22) Filed: May 8, 2025

Related U.S. Application Data
(60) Provisional application No. 63/688,981, filed on Aug. 30, 2024.

(51) Int. Cl. G01N 15/1434; G01N 15/01; G01N 15/10; G01N 15/1429

(52) U.S. Cl. CPC G01N 15/1434; G01N 15/01; G01N 15/1429; G01N 2015/1006

(57) ABSTRACT

An analytical method of and system for monitoring cell status whereby excitation energy is focused to an excitation cytometry volume in a cell sample to fluoresce first and second fluorophores of a cell. Fluorescence signals from the first and second fluorescing cell fluorophores are directed to a detection subsystem. A first peak in fluorescence intensity for the first fluorophore is detected as is a second peak in fluorescence intensity for the second fluorophore. The fluorescence signals are processed to identify when the first and second peaks occur substantially simultaneously indicating the presence of a cell at the excitation cytometry volume instead of background fluorescence and in response, the cellular status of the cell is measured using the intensity of the levels of the first and second peaks.

### RELATED APPLICATIONS

This application claims benefit of and priority to U.S. Provisional Application Ser. No. 63/688,981 filed Aug. 30, 2024, under 35 U.S.C. § § 119, 120, 363, 365, and 37 C.F.R. § 1.55 and § 1.78, which is incorporated herein by this reference.

### GOVERNMENT RIGHTS

This invention was made with U.S. Government support under Contract Nos. 1R43AT010840-01 and 2R44AT010840-02A1 awarded by the US National Institutes of Health. The Government has certain rights in the subject invention.

### FIELD OF THE INVENTION

This invention relates to an apparatus and method for real-time measurement of cellular-level redox metabolism. More specifically, this invention relates, in some embodiments, to an apparatus and method for real-time measurement of cellular-level redox metabolism of cells cultured in agitated bioreactors and fermenters for manufacturing of biologic therapeutics and natural products.

### BACKGROUND OF THE INVENTION

Bioreactors are specialized biological systems designed to cultivate and maintain cells and living organisms in an optimally controlled environment. Agitated bioreactors are widely used for manufacturing of a broad spectrum of biologic pharmaceuticals, including natural product medicines, vaccines, antibiotics, enzymes, proteins, viruses, cells and other biologically derived drugs and therapies. Advances in bioreactor and bioprocess development have revolutionized the biotechnology industry, promoting discovery of new therapeutics and improving the productivity and quality of biologic manufacturing. As a result, bioprocess development has become a rapidly evolving and highly invested field within the biotechnology and pharmaceutical industry.

The high complexity of the cell-culture bioprocesses and the end products pose unique challenges in the development and control of bioreactor operations. Accurate characterization and effective control of cell culture conditions are important to ensure host cell viability and functionality for efficient synthesis of biologic products. Effective process monitoring tools that provide accurate and timely feedback on the physiological status of cells play a crucial role in guiding efficient bioreactor controls and operations. Electronic and optical sensors have been demonstrated to measure critical process parameters such as pH, temperature, and concentrations of metabolites including dissolved oxygen (DO), glucose, and lactate. These in-line process monitoring tools rely on measurements of extracellular metabolites combined with metabolic flux modelling to infer cell physiology. However, these indirect measurements often lack the cellular-level details that are needed to fully understand and thus guide effective adjustments of the cultivation conditions.

Alternatively, offline analyses are often employed to characterize cell physiology at the cellular and molecular level. These include mass spectroscopy, optical spectroscopy, microscopy, and cytometry devices. However, offline measurements require extraction of culture samples at discrete time points and often provide delayed or unactionable feedback. Moreover, the requirements for complex and time-consuming sample preparation procedures and the potential for alteration of cell properties raise the debate whether the offline measurements are able to reflect the true physiology of cells in real bioreactor culture conditions. In addition, for certain types of bioprocesses, periodic sample extraction leads to a significant risk of batch contamination and failure, which can result in substantial costs.

U.S. Pat. Nos. 9,951,372; 9,945,860; and 11,885,568 are all incorporated herein by this reference.

### BRIEF SUMMARY OF THE INVENTION

Therefore, more effective in-line process analytical technology (PAT) tools are highly sought-after technologies in the rapidly growing biopharmaceutical industry. This strong market demand has led to substantial investment in the development of new PAT tools. For example, Ovizio has commercialized the iLine F microscope for real-time continuous monitoring of bioprocesses. Although providing sub-cellular resolution, this reflection-based microscopy technology only provides cell morphology information, missing important functional and molecular details of the cells. There have been research efforts to integrate cytometry technologies into bioreactor setups, but those require substantial modifications to the bioreactors significantly reducing the interests for adoption in the industry.

Provided herein is an improved method and apparatus for real-time, accurate monitoring of cell status in bioreactors for biopharmaceutical manufacturing bioprocess optimization.

An object of the instant invention is to provide a method and apparatus for real-time, continuous monitoring of cell redox metabolism at the cellular level in agitated bioreactors for bioprocessing of biopharmaceuticals with improved productivity and quality. The real-time measurement of cellular level redox metabolism is achieved by an in-line cytometry setup that simultaneously measures the ratio of the autofluorescence of fluorophores FAD (flavin adenine dinucleotide) and NAD(P)H (reduced nicotinamide adenine dinucleotide/phosphate) excited by, for example, two-photon absorption.

The bioreactor in-line cytometry technology for real-time measurements of cellular level reduction-oxidation (redox) metabolism has been demonstrated during yeast culture fermentation processing. This innovative in-line cytometry redox probe technology assesses cell metabolism by simultaneously measuring two-photon excited (TPE) fluorescence from NAD(P)H and FAD, two essential coenzymes involved in primary cell metabolism. The simultaneous measurements and ratio of the two fluorescence signals indicates the relative concentrations of the two coenzymes and thus the cellular-level redox metabolism. The TPE process confines the fluorescence emission within a sub-cellular volume, enabling high spatial discrimination and substantial reduction of background noise. When combined with the intrinsic flow dynamics of cell suspension in agitated bioreactors, the TPE fluorescence detection forms an in-line cytometry measurement scheme. During yeast culture fermenter experiments, the inventors demonstrated measurements that differentiated metabolic shifts associated with cells transitioning from the growth phase to the production phase during bioreactor operation. In addition to the metabolic measurement capability, the TPE fluorescence in-line cytometry technique can also be used for continuous measurement of other culture conditions such as cell density and viability. Although the current practice primarily focused on fermentation bioreactor processes for the production of natural products, the technology holds the potential to be used for various biopharmaceutical production processes for biologics manufacturing including protein therapy, cell therapy, and gene therapy. In addition to use within the pharmaceutical and natural products industries, the technology may also be applicable to monitoring other industrial uses of fermenters and bioreactors that cultivate biological cells, tissues or organisms, including the production of biofuels.

Disclosed is an optical apparatus and method for real-time measurement of cellular redox metabolism within a bioreactor using an in-line cytometry probe. The in-line cytometry measurements are achieved by combining the intrinsic flow dynamics of cells in agitated bioreactor cultures and a highly spatially confined one, two, three or more Photon Excitation (PE) fluorescence process. Due to the tight spatial confinement of the laser excitation and fluorescence detection processes, which is substantially smaller than the sizes of the cells, when a cell flows across the PE region, a signal peak will be generated in the temporal traces of both fluorescence detection channels. This forms an intrinsic flow cytometer wherein the cells are randomly sampled.

Featured is an optical apparatus and method for bioreactor in-line cytometry wherein the tight spatial confinement of the PE fluorescence is achieved by focusing a laser (e.g., a near-infrared (NIR) laser) and a high numerical aperture (NA) objective lens design. By focusing the pulsed NIR laser down to micron or submicron levels, the NAD(P)H and FAD fluorescence is excited through the PE (e.g., TPE) process. Due to the nonlinearity of the multiphoton excitation process, the fluorescence is tightly confined within the focal region. The tight spatial confinement leads to significantly reduced fluorescence background from the culture media, especially when a cell is at the focus, contributing to a high cell signal to culture media background ratio.

Also disclosed is an optical apparatus and method for bioreactor in-line cytometry wherein the tight NIR laser excitation focus is achieved by a high NA objective design using miniaturized low-cost optics. This results from the space requirement of the optical probe for integration into bioreactors for real-time in-line measurements. The high NA and optical performance are achieved by employing a combination of low aberration achromatic lenses, a high NA aspheric lens, and a half-ball lens. This design provides high on-axis performance while sacrificing the off-axis performance which is not required by this application.

Also disclosed is an optical apparatus and method for in-line cytometry wherein the FAD and NAD(P)H fluorescence is excited by a single laser source while being simultaneously detected by two separated channels. By synchronized detection of the two fluorescence signals, the cell peaks can be distinguished against background noise, due to the fact that the cell peaks simultaneously appear in both channels while background noise signal is randomly present in individual channels. Data analysis algorithms, some using cross-correlation, have been demonstrated to identify cell peaks, while other algorithms may be applicable. Additional fluorophores may be targeted using the same apparatus and method.

Featured is a process analytical method of monitoring cell status comprising focusing excitation energy to an excitation cytometry volume in a cell sample to fluoresce first and second fluorophores of a cell, directing fluorescence signals from the first and second fluorescing cell fluorophores to a detection subsystem, and detecting, in the fluorescent signals, a first peak in fluorescence intensity for the first fluorophore. The method further includes detecting, in the fluorescence signals, a second peak in fluorescence intensity for the second fluorophore and processing the fluorescence signals to identify when the first and second peaks occur substantially simultaneously indicating the presence of a cell at the excitation cytometry volume instead of background fluorescence. In response, cellular status of the cell is measured using the intensity of the levels of the first and second peaks.

The cell sample may be a cell culture located in a bioreactor or fermenter. Preferably, the excitation cytometry volume is between 0.01 and 100 microns³. In one example, the first cell fluorophore is NAD(P)H and the second cell fluorophore is FAD. The method can be executed in-line within a bioreactor or fermenter.

In one example, a laser beam is directed through a probe inserted into the cell culture. The detection subsystem preferably includes a detection channel in the probe for the fluorescent signals, and detecting the first peak in fluorescence intensity and detecting the second peak in fluorescence intensity includes spectrally separating the fluorescent signals from the detection channel of the probe.

Also featured is an in-line analytical system for monitoring cell status comprising a probe for insertion into a cell culture, the probe including a focusing optic for focusing excitation energy to an excitation cytometry volume in the cell culture, and a collection channel for fluorescence signals. The system includes an excitation source for directing excitation energy to the probe focusing optic, a first detection subsystem optically coupled to the collection channel of the probe and configured to detect a first peak in fluorescence intensity in a first fluorescent signal from a first fluorescing cell fluorophore a second detection subsystem optically coupled to the collection channel of the probe and configured to detect a second peak in fluorescence intensity in a second fluorescent signal from a second fluorescing cell fluorophore, and a signal processor, responsive to the first and second detector subsystems and configured to identify when the first and second peaks occur substantially simultaneously indicating the presence of a cell at the excitation cytometry volume instead of background fluorescence in order to measure cellular status using the intensity levels of the first and second peaks.

Also featured is an in-line cytometry system for monitoring cell status in agitated bioreactors comprising focusing excitation energy to an excitation cytometry volume that is smaller than a cell to fluorescence cells when present at a focal region of the excitation energy, randomly sampling cells that are moving across the excitation volume, and generating fluorescence time traces that contain cells peaks as the cells flow in the agitated bioreactor.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic view of a bioreactor in-line cytometry system;

FIGS. 2A-2C illustrate a bioreactor in-line cytometry measurement principle;

FIG. 3A-3E show views of an in-line cytometry probe;

FIGS. 4A-4C illustrate a Zemax optical design and performance simulation of an example TPE in-line cytometry probe;

FIG. 5 shows an example of data processing procedures: FIG. 5A, example raw data of TPE in-line cytometry measurement during a yeast fermentation bioreactor; FIG. 5B, processed data; and FIG. 5C, peaks identified from cells exhibiting both FAD and NAD(P)H peaks;

FIGS. 6A-6C show in-line cytometry measurements of yeast cell metabolism in response to rotenone addition indicated by the arrow;

FIGS. 7A-7B show in-line cytometry measurement of cellular redox metabolism during an entire yeast fermentation bioreactor operation (FIG. 7A), and corresponding dissolved oxygen/essure/residual glucose (FIG. 7B);

FIG. 8 shows in-line cytometry measurements of FAD fluorescence compared to offline NAD(P)H assay measurements; and

FIG. 9 shows in-line cytometry measurements of cell concentrations and comparison with off-line OD 600 measurements.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

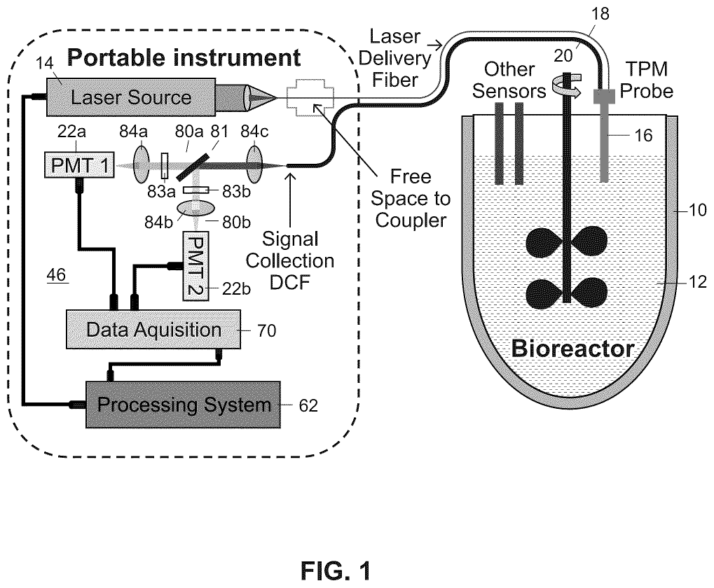

A bioreactor 10, FIG. 1 is widely used in pharmaceutical manufacturing and biotechnology industries. Microbes or mammalian cells 12 are cultured within bioreactors, where nutrient and key metabolite feeding is highly regulated to optimize cell function and final product synthesis. Due to the highly complex nature of the bioreactor processes, the effective in-line PAT tool of FIG. 1 characterizes and monitors the cell physiology and culture properties to guide effective adjustments of feeding strategies and the development of the more advanced bioprocesses.

The in-line cytometry system measures the autofluorescence of key intracellular metabolites, such as NAD(P)H and FAD to assess the redox metabolic state of individual cells in agitated bioreactors. The FAD/(FAD+NAD(P)H) fluorescence ratio is utilized to quantify the redox state in metabolic pathways. Other fluorescing metabolites may also be monitored using appropriate single-or multi-photon laser excitation wavelengths, optical filters, and optical detectors. Due to the nonlinear nature of the TPE process and its tight spatial confinement, the system selectively excites intracellular metabolites minimizing interference from compounds in the culture media. A similar approach may also be used in combination with confocal fluorescence/Raman spectroscopy detection due to the need to use high laser intensities to induce fluorescence and Raman scattering signals and the detection of multiple metabolites. This could also be accomplished using single photon excitation and the use of confocal detection optics that limit the capture of the fluorescence signals from outside of the focus of the excitation laser spot. When combined with the natural flow dynamics of the cells in agitated bioreactor cultures, this technology enables in situ, cytometry-level cell-physiology measurements without the need for sample extraction.

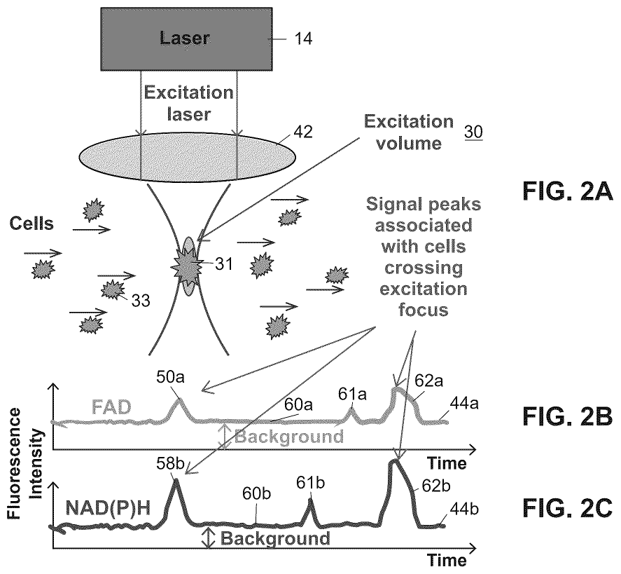

The in-line cytometry system includes ultrashort laser pulses (typically<1 ps or 10⁻¹² s) output from laser source 14 and delivered to a miniature optical probe 16 through a specialty fiber 18, e.g., a hollow core (HC) photonic crystal fiber. Exiting the HC fiber, the laser pulses are tightly focused into the cell culture within the bioreactor into an excitation cytometry volume 30, FIG. 2. Fluorescence is generated within the laser focal region which is preferably smaller than the cells. In this case, the fluorescence is generated within the cells when they are moving across the laser focal region. The fluorescence is collected by a fiber bundle or a large core fiber 20, FIG. 1 and then spectrally separated by optical filters and detected by two detectors, i.e., photomultiplier tubes (PMTs) 22a, 22b.

In agitated cell suspension bioreactors, the cells flow within the culture media. As shown in FIG. 2, when a cell flows across the laser focus 30, a distinct signal peak is formed in the temporal traces of the TPE fluorescence. This forms an intrinsic cytometry setup, where individual cells are randomly sampled. This invention leverages the synchronized detection of two fluorescence signals, e.g., NAD(P)H and FAD, which allows for high efficiency discrimination of cell signals against the background noise. This is based on the principle that a cellular signal peak simultaneously appears in both detection channels while background noise may randomly appear in either channel, but rarely in both channels. Advanced algorithms, e.g., cross-correlation, can be used to identify cellular signal peaks, although other algorithms may be used.

As shown in FIG. 2A, excitation energy from laser 14 is focused by optic 42 to an excitation cytometry volume 30 in a cell sample to fluoresce first and second fluorophores of a cell 31 (e.g., FAD and NAD(P)H enzymes). Fluorescence signals from the first 44a and second 44b fluorescing cell fluorophores are directed to detection subsystem 46, FIG. 1. A first peak 50a, FIG. 2B in fluorescence intensity for the first cell fluorophore is detected, for example by PMT 22a, FIG. 1. A second peak 50b, FIG. 2C in fluorescence intensity for the second cell fluorophore is detected, for example, by PMT 22b, FIG. 1. The fluorescence signals are processed by data acquisition module 70, FIG. 1 to identify when the first 50a and second 50b peaks (FIG. 2) occur substantially simultaneously indicating the presence of a cell at the excitation cytometry volume 30 instead of background fluorescence (as shown at 60a and 60b). In response, cell status such as cellular level redox metabolism of cell 31 is measured using the intensity of the levels of the first 50a and second 50b peaks using, for example, processing subsystem 70, FIG. 1 which may also control the laser source 14. In one example, the redox ratio is calculated based on the equation FAD/(FAD+NAD(P)H), which other equations such as FAD/NAD(P)H may be used.

Optic 81 is preferably a dichroic mirror (beam splitter) that separates the light by wavelength (or frequency). Signals 44a and 44b, FIGS. 2B-2C can be spectrally separated by optical filters, e.g., the dichroic mirror 81, FIG. 1 with a cutoff wavelength of 505 nm to separate the NAD(P)H (430-490 nm) from the FAD (500-580 nm). Additional filters 83a, 83b can be placed in front of the PMTs to ensure that the PMTs are only detecting light in the desired wavelength bands: NAD(P)H (430-490 nm) and FAD (500-580 nm). Collimating lenses 84a, 84b, and 84c may also be used.

The presence of FAD and NAD(P)H can be monitored using two dedicated photomultiplier tubes 22a, 22b, FIG. 1 each monitoring a specific wavelength (FAD 500-580 nm; NAD(P)H 430-490 nm). The collected signal from the bioreactor was separated from the excitation light source and each optical channel corresponding to FAD and NAD(P)H measurements. To eliminate any unwanted reflected laser light from the media and cells, a short-pass filter (FESH0600, THORLABS, range 390-600 nm) can be incorporated into the system. A dichroic mirror 81 with cutoff wavelength at 505 nm was employed to separate the FAD and NAD(P)H signals. Additionally, each channel was equipped with a bandpass filter tailored to the specific wavelength range required for FAD (FF01-540/80-25, Semrock) and NAD(P)H (FF01-460/60-25, Semrock) detection. FIGS. 2B-2C show another set of substantially simultaneous peaks 62a, 62b in the two different detection channels 80a, 80b, FIG. 1 of the in-line system for another cell 33 which enters excitation volume 30. Peaks 61a and 61b do not occur substantially simultaneously.

Peaks 50a, 50b occur substantially simultaneously because, for example, they occur within 1 μs offset of each other. Peaks 61a,61b do not occur substantially simultaneously because they do not occur within 1 μs offset of each other. Other time intervals to differentiate signals indicating the presence of a cell at the excitation volume as opposed to background noise may be used.

In one embodiment, an in-line analytical system for monitoring cell redox metabolism includes probe 16, FIG. 1 for insertion into a cell culture 12. The probe includes a focusing optic 42, FIG. 2 for focusing excitation energy to an excitation cytometry volume 30 in the cell culture. The probe includes a collection channel for fluorescence signals.

An excitation source such as laser 14 directs excitation energy to the probe focusing object. A first detection subsystem 80a, FIG. 1 is optically coupled to the collection channel of the probe and is configured to detect a first peak 50a, FIG. 2 in fluorescence intensity in a first fluorescent signal from a first fluorescing cell. A second detection subsystem 80b is optically coupled to the collection channel of the probe and configured to detect a second peak 50b in fluorescence intensity in a second fluorescent signal from a second fluorescing cell. A signal processor, such as data acquisition module 70 and/or processing subsystem 62 is responsive to the first and second detector subsystems and configured to identify when the first and second peaks occur substantially simultaneously indicating the presence of a cell at the excitation cytometry volume 30, FIG. 2 instead of background fluorescence 60a, 60b in order to measure cellular level redox metabolism using the intensity levels of the first 50a and second 50b peaks.

To enable real-time continuous cytometry measurements of cell properties, a miniaturized optical probe 16 is inserted into the bioreactor through a sensor port to provide high optical performance and enable efficient fluorescence generation and detection.

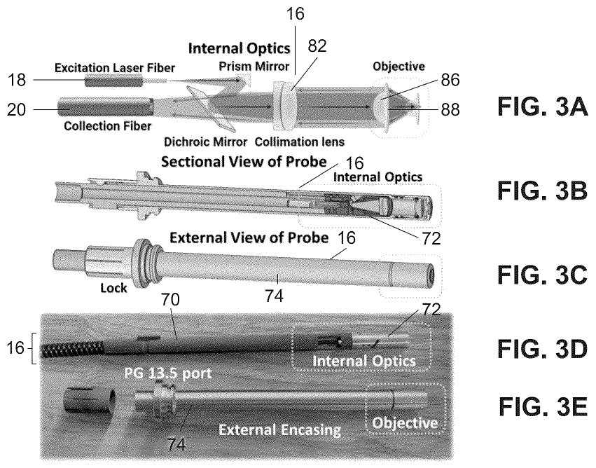

The mechanical and optical designs of a redox probe developed are shown in FIGS. 3A-3E. The mechanical structure of the probe has four major parts, i.e., 1) a brass barrel 72 that contains key optical components; 2) a 3-D printed plastic part 70 that holds the brass barrel, 3) a stainless steel outer tube 74 that contains the aforementioned components and interfaces with the bioreactor culture, and 4) a high NA objective assembly. The brass barrel and the 3-D printed part can be separated from the outer tube, in which case only the outer tube and the objective are left within the bioreactor. The outer tube and the objective are autoclavable for sterilization without affecting the optics and fibers that are contained within the brass barrel and the 3-D printed part. The outer tube has an outer diameter of 12 mm, which can interface smoothly with bioreactors through a standard PG13.5 sensing port.

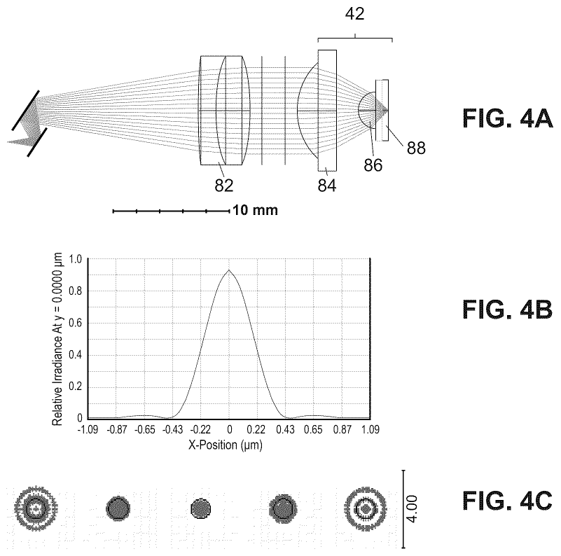

The optical design and performance of an exemplary probe are shown in FIGS. 4A-4C. One component is the high NA objective including an achromatic lens 82, a high-power aspheric lens 84, a half-ball lens 86, and a BK7 glass window 88. This arrangement of lenses constitutes an objective lens with a diffraction-limited NA of 0.71 when operating in water. The largest component is the aspheric lens that has a diameter of 9.8 mm. The use of the miniature lenses enables the entire objective assembly to pass through a PG 13.5 sensing port to be immersed into the bioreactor culture. See FIGS. 4B and 4C. There is a quasi-collimated location between the achromatic lens located within the brass barrel and the aspheric lens located within the objective. This enables a large tolerance for the positioning accuracy of the brass barrel and 3-D print assembly when being inserted into the stainless steel outer tube.

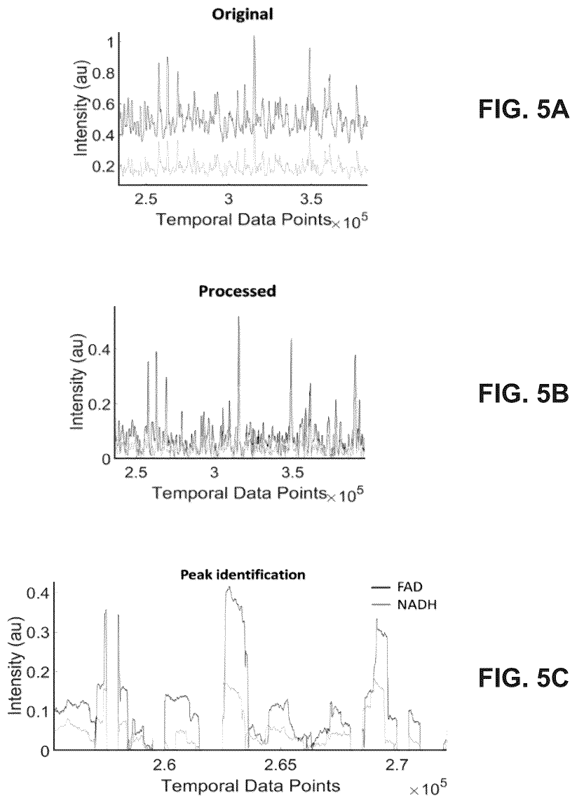

One example of the measurement capability of this in-line cytometry probe is the real-time measurement of cellular redox based on NAD(P)H and FAD fluorescence. FIG. 5 shows example data of NAD(P)H and FAD fluorescence signals collected from yeast cells cultured in an agitated bioreactor. The fluorophores were excited by laser pulses at a central wavelength of 785 nm with a pulse width of approximately 120 fs resulting in fluorescence signals captured by the probe optics. Other laser sources at different wavelengths may be used to excite other relevant intracellular fluorophores. The NAD(P)H and FAD fluorescence signals were measured using two dedicated photomultiplier tubes (PMTs). Alternative high-speed detectors such as avalanche photodiodes (APDs) or amplified photodiodes may also be used. Each PMT monitored a specific wavelength band that overlapped with the fluorescence emission band of NAD(P)H or FAD, specifically 430-490 nm or 500-580 nm, respectively. As those proficient in the field would know, the wavelength bands of the optical filters may be adjusted. This is feasible provided that the signal from each target fluorophore correlates with relative concentrations of the fluorophores. Distinctive signal peaks, which are associated with individual cells, stand out from the baseline of the background fluorescence originating from the culture media.

To distinguish the cells from the background, data analysis algorithms can be used that leverage the correlation of the presence of cell peaks in the two channels. As an example, algorithms including low-pass filtering for DC background removal and cross-correlation for peak identification were used to process the raw data in FIG. 5A. The processed data is shown in FIGS. 5B and 5C which show the background removed data and identified cell peaks. These are example data processing algorithms and routines, and other approaches used for processing cytometry data may be applicable in this case.

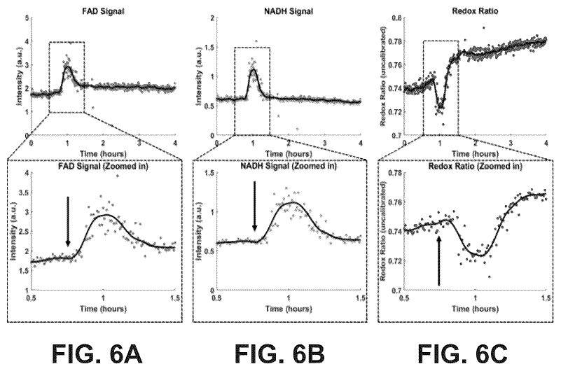

The in-line cytometry data offers rich information regarding the cell physiology status and culture conditions. In particular, the cellular-level redox metabolism can be calculated based on the NAD(P)H and FAD fluorescence. FIG. 6 shows the cellular redox changes of yeast cell culture before and after addition of rotenone. By inhibiting Complex I of the mitochondrial electron transport chain, rotenone disrupts oxidative phosphorylation in yeast cells. This disruption leads to an increased NAD(P)H/FAD ratio, which is reflected by the decreased redox ratio measured by the in-cytometry probe.

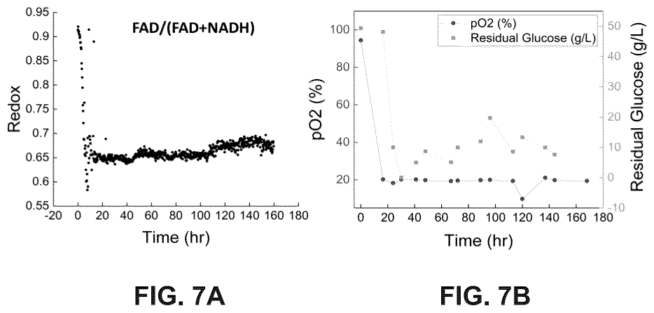

FIGS. 7A-7B shows an example of continuous monitoring of redox metabolism across an entire fermentation process in a yeast culture bioreactor. Redox changes, including the initial high level, rapid decrease, and later stabilized, slow variations are observed. These observations are consistent with the hypothesis of the initial stress experienced by the cells, and rapid adaptation, and the transition from growth phase to production phase. These observations are correlated with the measured dissolved oxygen and glucose measurements, although these other measurements are only provided at discrete time intervals (data points).

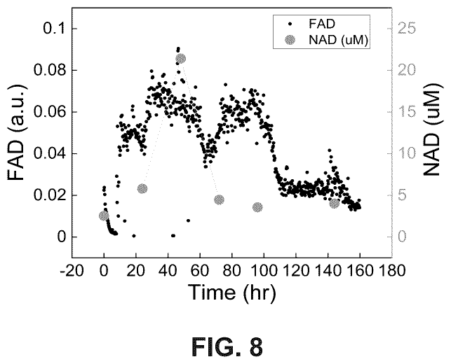

The in-line cytometry measurement was also validated with off-line measurements as shown in FIG. 8. The NAD levels (measured in μM) exhibit a similar trend to FAD, showing the initial stage of cell recovery and proliferation before reaching the maximum level at the 40-hour time point, which corresponds to the production stage. The temporal discrepancy between these two measurements is primarily due to the low temporal resolution provided by the offline measurements. Nevertheless, the overall trend across the entire bioreactor formation process appears to be consistent between the two measurements.

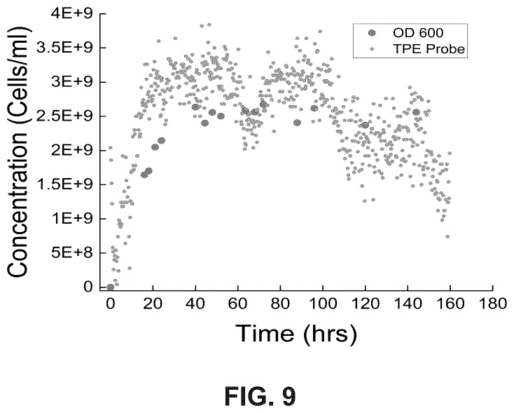

Additional information is embedded in the in-line cytometry data, including cell density. FIG. 9 shows an example of tracking cell density in a fermentation bioreactor process. This capability is achieved by analyzing the cytometry data of the FAD channel using peak identification algorithms to identify individual signal peaks. A similar approach could also use the NAD(P)H channel or both channels. After calibration, the cell density measured with the in-line cytometry probe correlates well with the OD 600 instrument measurements. It is noted that OD 600 measurements require periodic sample extraction and only provide discrete data points. Furthermore, the OD 600 measurement is unable to differentiate between viable and dead cells. This results in minimal fluctuation in cell count compared to the system measurement. The measurement, in contrast, relies on the count of viable cells that exhibit both NAD(P)H and FAD signals.

In the examples, Two Photon Excitation (TPE) was employed. But, if the laser wavelength is adjusted, for Nicotinamide adenine dinucleotide (phosphate) NAD(P)H, one photon absorption is between 300-390 nm, two photon absorption is between 600-780 nm, and three photon absorption is between 900-1170 nm. Emission is 400-600 nm with peaks at 465 nm. For Flavin adenine dinucleotide FAD, one photon absorption is between 300-500 nm, two photon absorption is between 600-1000 nm, and three photon absorption is between 900-1500 nm. Emission is 490-620 nm with peaks at 530 nm. The use of single photon excitation would leverage the confocality of the detection optics to still enable the cytometry-based detection scheme in combination with the simultaneous detection of both fluorescence signals.

The requirements for the pulsed laser pulse width will change depending on whether it is 1, 2, or 3-photon absorption. For 1-photon absorption the laser can be pulsed or continuous wave (not pulsed). For 2-photon and 3-photon it can be nanosecond (ns) to less than 1 picosecond (ps) pulses.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

What is claimed is:

1. A process analytical method of monitoring cell status, the method comprising:
focusing excitation energy to an excitation cytometry volume in a cell sample to fluoresce first and second fluorophores of a cell;
directing fluorescence signals from the first and second fluorescing cell fluorophores to a detection subsystem;
detecting, in the fluorescent signals, a first peak in fluorescence intensity for the first fluorophore;
detecting, in the fluorescence signals, a second peak in fluorescence intensity for the second fluorophore;
processing the fluorescence signals to identify when the first and second peaks occur substantially simultaneously indicating the presence of a cell at the excitation cytometry volume instead of background fluorescence; and
in response, measuring cellular status of the cell using the intensity of the levels of the first and second peaks.

2. The method of claim 1 in which the cell sample is a cell culture located in a bioreactor or fermenter.

3. The method of claim 1 in which the excitation cytometry volume is between 0.01 and 100 microns³.

4. The method of claim 1 in which the first cell fluorophore is NAD (P)H and the second cell fluorophore is FAD.

5. The method of claim 1 executed in-line within a bioreactor or fermenter.

6. The in-line method of claim 5 in which focusing includes directing a laser beam through a probe inserted into the cell culture, directing fluorescent signals to the detection subsystem includes a detection channel in the probe for the fluorescent signals, and detecting the first peak in fluorescence intensity and detecting the second peak in fluorescence intensity includes spectrally separating the fluorescent signals from the detection channel of the probe.

7. An in-line analytical system for monitoring cell status, the system comprising:
a probe for insertion into a cell culture, the probe including:
a focusing optic for focusing excitation energy to an excitation cytometry volume in the cell culture, and
a collection channel for fluorescence signals;
an excitation source for directing excitation energy to the probe focusing optic;
a first detection subsystem optically coupled to the collection channel of the probe and configured to detect a first peak in fluorescence intensity in a first fluorescent signal from a first fluorescing cell fluorophore;
a second detection subsystem optically coupled to the collection channel of the probe and configured to detect a second peak in fluorescence intensity in a second fluorescent signal from a second fluorescing cell fluorophore; and
a signal processor, responsive to the first and second detector subsystems and configured to identify when the first and second peaks occur substantially simultaneously indicating the presence of a cell at the excitation cytometry volume instead of background fluorescence in order to measure cellular status using the intensity levels of the first and second peaks.

8. The system of claim 7 in which the cell culture is present in a bioreactor or a fermenter and the probe is inserted into the bioreactor or fermenter.

9. The system of claim 7 in which the focusing optic focuses fluorescence excitation energy to an excitation cytometry volume of between 0.01 and 100 microns³.

10. The system of claim 7 in which the first cell fluorophore is NAD (P)H and the second fluorophore cell is FAD.

11. The system of claim 7 in which the excitation source is a pulsed laser beam source.

12. An in-line cytometry system for monitoring cell status in agitated bioreactors, the method comprising:
focusing excitation energy to an excitation cytometry volume that is smaller than a cell to fluorescence cells when present at a focal region of the excitation energy;
randomly sampling cells that are moving across the excitation volume; and
generating fluorescence time traces that contain cells peaks as the cells flow in the agitated bioreactor.
